(19) United States
(12) Patent Application Publication
(10) Pub. No.: US 2006/0042677 A1
(43) Pub. Date: Mar. 2, 2006

(54) Solid-state image pickup device

(75) Inventors: Toshiaki Fukunaga, Kanagawa (JP); Daisuke Yokoyama, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/206,851

(22) Filed: Aug. 19, 2005

(30) Foreign Application Priority Data
Aug. 24, 2004 (JP) 2004-244081

(51) Int. Cl. H02N 6/00

(52) U.S. Cl. 136/243

(57) ABSTRACT

The present invention provides a solid state image pickup device, including a silicon substrate and a photoelectric conversion unit which receives external incident light and generates signals in accordance therewith, and which is formed on or above the surface of the silicon substrate, wherein a signal transmission circuit for reading out the signals generated in the photoelectric conversion unit is formed on the silicon substrate; the photoelectric conversion unit includes a photoelectric conversion layer which has a laminated structure of plural compound semiconductor layers, which are different from each other in light wavelength to absorb and are provided with the laminated structure so that the shorter a light absorption wavelength of a compound semiconductor layer is, the closer to a light incident side the compound semiconductor layer resides; and the plural compound semiconductor layers are respectively connected to pixel electrodes formed on the signal transmission circuit.

### CROSS-REFERENCE TO RELATED APPLICATION

This application claims priority under 35 USC 119 from Japanese Patent Application No. 2004-244081, the disclosure of which is incorporated by reference herein.

### BACKGROUND OF THE INVENTION

1. Field of the Invention

The present invention relates to a solid-state image pickup device which is applicable to any other apparatuses including digital cameras, video cameras, facsimile machines, scanners, copying machines and the like, and any other optical sensors including bio-sensors, chemical sensors and the like. Particularly, the present invention relates to a solid-state image pickup device which has a laminated type photoelectric conversion layer.

2. Description of the Related Art

Solid state image pickup devices having a structure in which a photoelectric conversion layer is provided on the plane almost identical with that of a charge transfer path have had disadvantages accompanying higher integration of pixels such as light loss in a color filter a and lower transmission of light to the photoelectric conversion layer due to the reduction in the size of the pixels almost to the wavelength of light. In addition, detection of three RGB colors at different positions has resulted in separation of colors and generation of false color, and to avoid the problem, such a device requires an additional optical low pass filter, which also caused light loss of its own. Thus, conventional solid state image pickup devices have had a problem of low efficiency in utilizing light.

Photoelectric conversion layers in a laminated structure have been proposed to overcome these problems (Japanese Patent Application Laid-Open (JP-A) Nos. 5-152554 and 9-64406). These proposed photoelectric conversion layers, which are made of an amorphous crystal or multicrystal (polycrystal), lead to problems of after-image and larger dark current and thus have yet to be put to practical use.

Alternatively, color sensors having a photoelectric conversion layer (light-receiving unit) in a laminated structure that performs color separation in a depth direction by utilizing the dependence of an absorption coefficient of Si on wavelength have been proposed (e.g., U.S. Pat. Nos. 5,965,875 and 6,632,701, and JP-A No. 7-38136). Such color sensors, however, still have a problem of unsatisfactory color separation in the laminated light-receiving unit because of the broader dependence of spectral sensitivity on wavelength.

Further, a photoelectric conversion layer having a laminated structure of three organic semiconductor layers ahs been proposed (JP-A No. 2003-234460). The proposed conversion layer also has problems of low durability and sensitivity and has not yet to been put to practical use.

### SUMMARY OF THE INVENTION

The present invention has been achieved in view of such conventional problems. Namely, the invention provides a solid state image pickup device having a favorable photoelectric conversion layer that allows dense integration of pixels, high-sensitivity photoelectric conversion, and high-grade color separation with less generation of false color and after-image.

Namely, the present invention provides a solid state image pickup device, comprising a silicon substrate and a photoelectric conversion unit which receives external incident light and generates signals in accordance therewith, and which is formed on or above the surface of the silicon substrate, wherein a signal transmission circuit for reading out the signals generated in the photoelectric conversion unit is formed on the silicon substrate; the photoelectric conversion unit comprises a photoelectric conversion layer which comprises a laminated structure of plural compound semiconductor layers, which are different from each other in light wavelength to absorb and are provided within the laminated structure so that the shorter a light absorption wavelength of a compound semiconductor layer is, the closer to a light incident side the compound semiconductor layer resides; and the plural compound semiconductor layers are respectively connected to pixel electrodes formed on the signal transmission circuit.

In the solid state image pickup device according to the invention having a photoelectric conversion unit containing a laminated photoelectric conversion layer of multiple semiconductor layers, the multiple semiconductor layers perform color separation in a depth direction and generate signals (signal charges or currents) corresponding to incident light of respectively different wavelengths in the same light-receiving area, and the respective signals are read out via pixel electrodes by a signal transmission circuit. Compound semiconductor layers are used as the semiconductor layers constituting such a photoelectric conversion unit. The compound semiconductor layers have favorable crystallinity and lattice match, and thus are higher in charge transfer speed, have a smaller amount of dark current, and are resistant to defects, and thus can be made to have a larger area. Thus, the solid state image pickup device having a favorable laminated photoelectric conversion layer allows integration of a greater number of pixels, high-sensitivity photoelectric conversion, and high-grade color separation with less generation of false color and after-image.

In one embodiment of the present invention, the photoelectric conversion layer comprises a laminated structure of first to third compound semiconductor layers arranged in this order along a light-incident direction; the first compound semiconductor layer comprises an InAlP layer; the second compound semiconductor layer comprises an InGaAlP layer; and the third compound semiconductor layer comprises a layer selected from the group consisting of an InGaP layer, a GaAs layer and an InGaAsP layer.

In the above embodiment, the first compound semiconductor layer preferably has a band gap within a range of 440 to 480 nm; the second compound semiconductor layer preferably has a bang gap at 520 to 580 nm; and the third compound semiconductor layer preferably has a band gap within a range of 600 nm or greater wavelength region.

In such a configuration, RGB color separation is performed in the photoelectric conversion unit, and it is therefore possible to read out the signals corresponding to the light of various colors by the signal transmission circuit.

Further, in the above embodiment, the third compound semiconductor layer preferably contains an InGaP layer. This configuration eliminates the need to provide an infrared blocking filter.

Additionally, it is preferable in the invention that a light-shielding film is formed on or above the photoelectric conversion unit except for a light-receiving surface of the photoelectric conversion unit. This configuration effectively prevents color mixing even when the solid state image pickup devices (or photoelectric conversion units) are arrayed.

### BRIEF DESCRIPTION OF THE DRAWINGS

FIG. 1 is schematic drawing illustrating the configuration of a first embodiment of the solid-state image pickup device of the present invention;

FIGS. 2A-2E are schematic drawings illustrating the production process for the first embodiment of the solid-state image pickup device of the present invention;

FIG. 3 is schematic drawing illustrating the configuration of a second embodiment of the solid-state image pickup device of the present invention;

FIG. 4 is schematic drawing illustrating the configuration of a third embodiment of the solid-state image pickup device of the present invention;

FIG. 5 is schematic drawing illustrating the configuration of a fourth embodiment of the solid-state image pickup device of the present invention; and

FIGS. 6A-6N are schematic drawings illustrating the production process for the fourth embodiment of the solid-state image pickup device of the present invention.

### DETAILED DESCRIPTION OF THE INVENTION

Hereinafter, the present invention is explained in detail by referring to the figures. In the figures and the following explanations, memberes having substantially the same function are given the same refrence number.

### First Embodiment of the Solid-State Image Pickup Device of the Present Invention

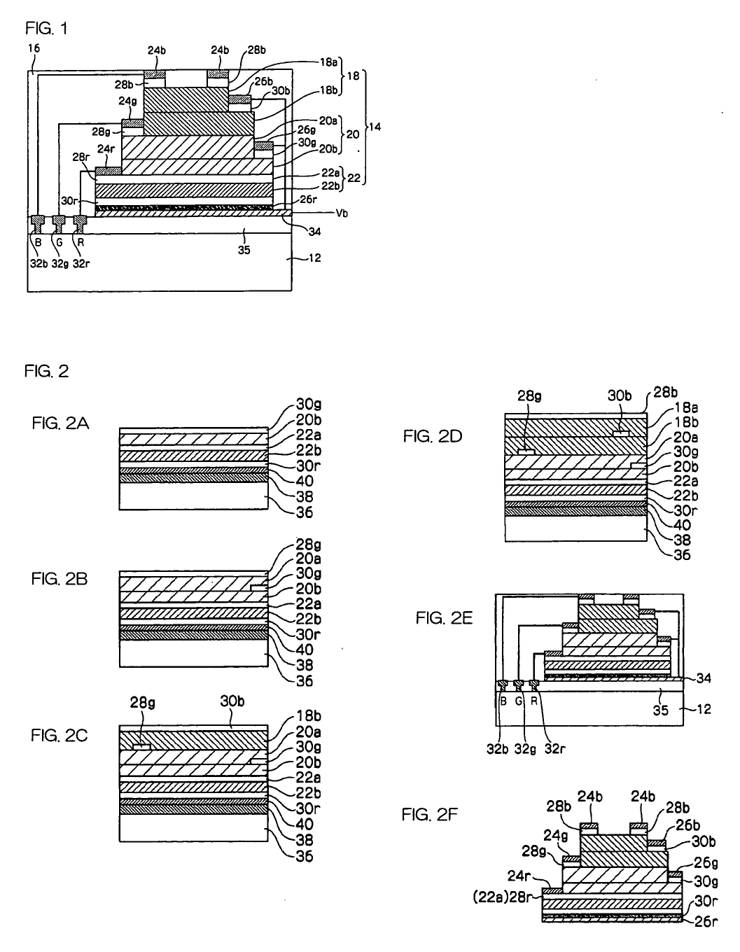

FIG. 1 is schematic drawing illustrating the configuration of a first embodiment of the solid-state image pickup device of the present invention. FIGS. 2A-2E are schematic drawings illustrating the production process for the first embodiment of the solid-state image pickup device of the present invention.

In a solid state image pickup device 10 according to the present embodiment, a photoelectric conversion unit 14 is formed on a signal transmission circuit board 12 (silicon substrate) having a signal transmission circuit (not shown in the figures) formed thereon. The solid state image pickup device 10 is sealed with an insulating sealer 16, except for a light-receiving surface of the photoelectric conversion unit 14. Although not shown in the figures, a transparent insulation film may be formed over the top layer of the photoelectric conversion unit 14 for protection of the light-receiving surface.

The photoelectric conversion unit 14 has a configuration in which a first photoelectric conversion layer 18 of InAlP having a band gap within a range of 440 to 480 nm (first compound semiconductor layer: InAlP layer), a second photoelectric conversion layer 20 of InGaAlP having a band gap within a range of 520 to 580 nm (second compound semiconductor layer: InGaAlP layer), and a third photoelectric conversion layer 22 of GaAs having a band gap within a range of 600 nm or greater (third compound semiconductor layer: GaAs layer) are laminated from the light-receiving surface. The respective photoelectric conversion layers are laminated in the order that light absorption wavelength (band gap) thereof become longer in a direction from the top layer to the bottom layer. Namely, the further upward and closer to the light-receiving surface a layer is, the shorter the light absorption wavelength (band gap) of the photoelectric conversion layer is.

The first photoelectric conversion layer 18 is constituted by an n-InAlP layer 18a and a p-InAlP layer 18b. The second photoelectric conversion layer 20 is constituted by an n-InGaAlP layer 20a and a p-InGaAlP layer 20b. The third photoelectric conversion layer 22 is constituted by an n-GaAs layer 22a and an i-GaAs layer 22b.

In addition, n-side (n-) electrodes 24r, 24g, and 24b, and p-side (p-) electrodes 26r, 26g, and 26b constituted by solder or the like are provided at the respective photoelectric conversion layers. For ohmic contact with respective electrodes, n-electrodes 24r, 24g, and 24b and p-electrodes 26r, 26g, and 26b are provided at the respective photoelectric conversion layers, respectively via contact layers 28r, 28g, and 28b formed from n-GaAs and contact layers 30r, 30g, and 30b formed from p-GaAs. The n-GaAs layer 22a also functions as the contact layer 28r.

Respective photoelectric conversion layers are connected via n-electrodes 24r, 24g, and 24b to pixel electrodes 32r, 32g, and 32b (respectively corresponding to R, G, and B signal read-out electrodes) formed on the signal transmission circuit board 12, and via p-electrodes 26r, 26g, and 26b to the earth respectively. However, the third photoelectric conversion layer 22 is connected via the p-electrode 26r formed on the lower layer to a common electrode 34.

When light enters into the same light-receiving surface, the first photoelectric conversion layer 18 absorbs blue light and generates a B signal, the second photoelectric conversion layer 20 absorbs green light and generates a G signal, and the third photoelectric conversion layer 22 absorbs red light and generates a R signal, sequentially from the light-receiving surface. The RGB signals are then sent via respective pixel electrodes 32r, 32g, and 32b to the signal transmission circuit. In this manner, the photoelectric conversion unit 14 (photoelectric conversion layers) performs color separation in the depth direction (three colors of R, G, and B in this embodiment), generating signals corresponding to the incident light of respectively different in wavelengths.

The signal transmission circuit board 12 is a silicon substrate on which a signal transmission circuit (not shown in the figures) is formed by a semiconductor process. In addition, pixel electrodes 32r, 32g, and 32b (R, G, and B signal read-out electrodes) are formed for transmission of the signals generated in the photoelectric conversion unit 14 to the signal transmission circuit. Further, a common electrode 34 is formed thereon via an insulation layer 35.

A conventionally color read out circuit can be used for signal transmission circuit. Signal charge or signal current, resulting from optical/electric conversion in the photoelectric conversion unit 14 (hereinafter called as a “light receiving section”), is accumulated in the light receiving section itself or an added capacitor. The accumulated electric charge is read out with the selection of the pixel location by the technique for so-called charge coupled devices (CCD) or the technique for a MOS type image pickup device (so-called CMOS sensor) using an X-Y address method. For an appropriate method of readout transfer there is a method of readout according to which, by a transfer switch the charge signal of a pixel is transferred to an analogue shift register using a charge transfer unit, and by the operation of the register the signal is read out by a read out terminal. Methods such as line address, frame transfer and interline transfer, and frame interline transfer types may be listed. Also, for CCDs, known are two phase constructions, 3 phase constructions, or 4 phase constructions, and further constructions with buried channels. In the invention the construction is not particularly restricted and any construction can be appropriately used.

Examples of address selection methods further include a method that sequentially selects one pixel at a time with a multiplexer switch and a digital shift register, and reads it out to the common output line as a signal voltage (or charge). The two-dimensionally arrayed X-Y address-based image pickup device is known as a CMOS sensor. In this sensor, a switch provided for a pixel connected to an X-Y intersecting point is connected to a vertical shift register. When the switch is turned on with a voltage from a vertical scanning shift register, the signal, read out from the pixels provided in the same row, is read out to the output line in the row direction. These signals are sequentially read out at the output terminal through a switch driven by a horizontal scanning shift register.

For reading out the output signal, a floating diffusion detector or a floating gate detector can be used. In addition, by providing a signal amplification circuit for the pixel section or using a technique, such as correlated double sampling, a signal-to-noise ratio (S/N) can be improved.

For signal processing, gamma correction by an ADC circuit, digitization by an AD converter, brightness signal processing, or color signal processing can be performed. Examples of color signal processing include white balance processing, color separation processing, color matrix processing, and the like. When the image pickup device of the present invention is used with an NTSC signal, RGB signals can be converted to YIQ signals.

Hereinafter, a process for producing the solid state image pickup device 10 of this embodiment will be described. The following compound semiconductor layers can be formed, for example, by organic metal gas-phase growth or molecular beam epitaxial growth.

As shown in FIG. 2A, a GaAs buffer layer 38 and an InGaP etch-blocking layer 40 are first formed one by one on a GaAs substrate 36. A p-GaAs contact layer 30r, an i-GaAs layer 22b, an n-GaAs layer 22a, a p-InGaAlP layer 20b, and a p-GaAs contact layer 30g are then formed thereon.

Then, as shown in FIG. 2B, the top p-GaAs contact layer 30g is then removed by normal lithography while leaving part of it as it is, exposing the p-InGaAlP layer 20b. An n-InGaAlP layer 20a and an n-GaAs contact layer 28g are then formed thereon.

As shown in FIG. 2C, the top n-GaAs contact layer 28g is removed by normal lithography while leaving part of it as it is at an area different from that of the lower p-GaAs contact layer 30g, exposing the n-InGaAlP layer 20a. A p-InAlP layer 18b and p-GaAs contact layer 30b are then formed thereon.

Then, the top p-GaAs contact layer 30b in FIG. 2D is removed by normal lithography while leaving part of it as it is at an area different from those of the lower p-GaAs contact layer 30g and n-GaAs contact layer 28g, exposing the p-InAlP layer 18b. An n-InAlP layer 18a and an n-GaAs contact layer 28b are then formed thereon.

As shown in FIG. 2E, the respective GaAs contact layers are exposed by normal lithography and dry etching techniques, (excluding the bottom p-GaAs contact layer 30r; the top n-GaAs contact layer 28b is patterned), and AuGe/Ni/Au films are formed respectively as n-electrodes 24r, 24g, and 24b and Ti/Pt/Au films are formed respectively as p-electrodes 26g and 26b, on the respective GaAs contact layers (excluding the p-GaAs contact layer 30r).

Then, a GaAs substrate 36 is adhered to a glass substrate not shown in the figures via a resin film, for protection of the epitaxial growth face. Then, as shown in FIG. 2F, the GaAs substrate 36 and the GaAs buffer layer 38 are removed with an ammonia-based etchant. The InGaP etch-blocking layer 40 is then removed with a hydrochloric acid-based etchant, exposing the p-GaAs contact layer 30r, on which a Ti/Pt/Au film is then formed as a p-electrode 26r.

In this manner, a laminated photoelectric conversion unit 14 having, from the light-receiving surface, the first photoelectric conversion layer comprising an n-InAlP layer 18a and a p-InAlP layer 18b, the second photoelectric conversion layer 20 comprising an n-InGaAlP layer 20a and a p-InGaAlP layer 20b, and the third photoelectric conversion layer 22 comprising an n-GaAs layer 22a and an i-GaAs layer 22b is prepared.

As shown in FIG. 2G, a photoelectric conversion unit 14 is then formed by connecting the common electrode 34 patterned in a particular shape and the bottom layer p-electrode 26r onto a signal transmission circuit board 12 separately prepared. At this time, the glass substrate is removed together with the resin film. Subsequently, after forming a SiO₂ layer as a sealer 16, viaholes, viaplugs, and the like, the respective photoelectric conversion layers in the photoelectric conversion unit 14 are connected respectively via the n-electrodes 24r, 24g, and 24b to the pixel electrodes 32r, 32g, and 32b (R, G, and B signal read-out electrodes) formed on the signal transmission circuit board 12 and via the p-electrodes 26g and 26b to the earth.

In this way, the solid state image pickup device 10 according to this embodiment is prepared. In particular in this embodiment, it is possible to obtain high etching selectivity and perform lithography and dry etching easily by properly selecting the materials for the respective layers of the photoelectric conversion unit 14.

In the solid state image pickup device 10 according to this embodiment described above, compound semiconductor layers having favorable crystallinity and lattice match are used as the photoelectric conversion layers constituting the laminated photoelectric conversion unit 14, and thus the laminated photoelectric conversion unit 14 is higher in charge transfer speed, has a smaller amount of dark current, and is resistant to defects, and thus can be made to have a larger area. Accordingly, the solid state image pickup device 10 according to this embodiment, which has favorable photoelectric conversion layers, allows integration of a greater number of pixels, high-sensitivity photoelectric conversion, and high-grade color separation, with less generation of false color and after-image. In addition, the photoelectric conversion unit 14 allows high-speed charge transfer, providing favorable images without the problem of after-image even during high-speed driving of, for example, digital video images.

In particular, InAlP having a band gap within a range of 440 to 480 nm (first photoelectric conversion layer 18), InGaAlP having a band gap within a range of 520 to 580 nm (second photoelectric conversion layer 20), and GaAs having a band gap within a range of 600 nm or greater (third photoelectric conversion layer 22) have a crystallinity and a complete lattice match higher than those, for example, of nitride-based compound semiconductors, and thus, provide a photoelectric conversion unit 14 which is higher in charge transfer speed, has a smaller the amount of dark current, and is resistant to defects, and which can be made to have a larger area.

In the solid state image pickup device 10 according to this embodiment, a GaAs film was exemplified as the red light-absorbing third photoelectric conversion layer 22 (third compound semiconductor layer), but alternatively, InGaP or InGaAsP, which lattice match with GaAs, may be used instead of GaAs. In particular, an infrared blocking filter (not shown in the figure) is generally needed for a solid state image pickup device 10, but use of an InGaP film as the red light-absorbing third photoelectric conversion layer 22 eliminates the need for the infrared blocking filter.

In addition, the solid state image pickup device 10 of this embodiment, which can separate light incident at the same (planar) position into various colors, eliminates the problem of false color due to a difference in light-receiving position, and thus theoretically eliminates the need for a low pass filter. Because the photoelectric conversion unit 14 is formed over the signal transmission circuit board 12, the light-receiving surface of the photoelectric conversion unit 14 may be widened, compared to the case where a photoelectric conversion unit 14 is formed in the same plane as the signal transmission circuit provided on the signal transmission circuit board 12, which allows reduction of pixel size and higher integration of the pixels.

### Second Embodiment of the Solid-State Image Pickup Device of the Present Invention

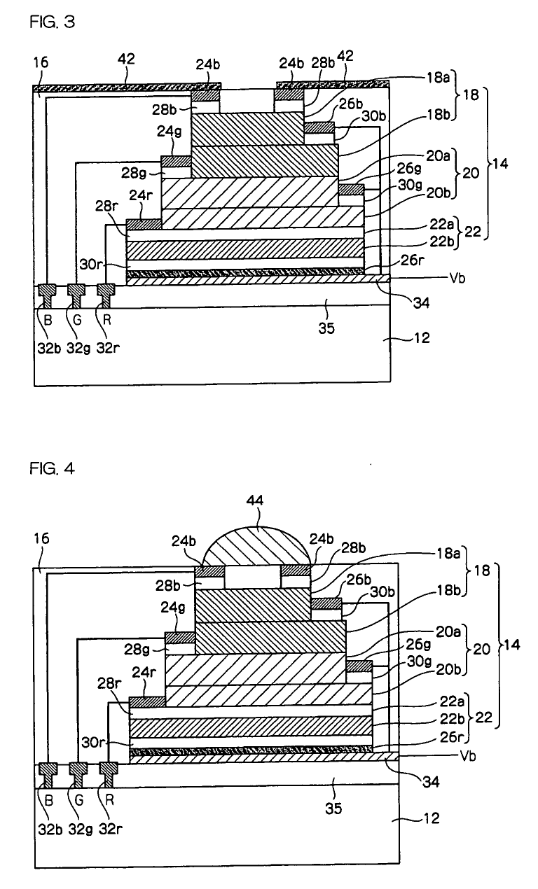

FIG. 3 is schematic drawing illustrating the configuration of a second embodiment of the solid-state image pickup device of the present invention.

In the solid state image pickup device 10 of this embodiment, a light-shielding film 42 is formed on a photoelectric conversion unit 14 except on its light-receiving surface. The light-shielding film 42 can be formed, for example, by masking the light-receiving surface and depositing a metal material on the sealer 16 of the photoelectric conversion unit 14. Aside from this, the structure is the same as in the first embodiment, and thus, description thereof is omitted.

In the solid state image pickup device 10 of this embodiment, by forming a light-shielding film 42 on the photoelectric conversion unit 14 and thus shielding the unit from light except at the light-receiving surface, it becomes possible to effectively prevent color mixing even when the solid state image pickup devices 10 (or photoelectric conversion units 14) are arrayed.

### Third Embodiment of the Solid-State Image Pickup Device of the Present Invention

FIG. 4 is schematic drawing illustrating the configuration of a third embodiment of the solid-state image pickup device of the present invention.

In the solid state image pickup device 10 of this embodiment, a microlens 44 is formed on or above the light-receiving surface of the photoelectric conversion unit 14. Aside from this, the structure is the same as in the first embodiment, and thus, description thereof is omitted.

The solid state image pickup device 10 of this embodiment, which has a microlens 44 formed on or above the light-receiving surface of the photoelectric conversion unit 14, has a higher incident light-converging efficiency, allowing more effective increase in sensitivity and higher color separation.

### Fourth Embodiment of the Solid-State Image Pickup Device of the Present Invention

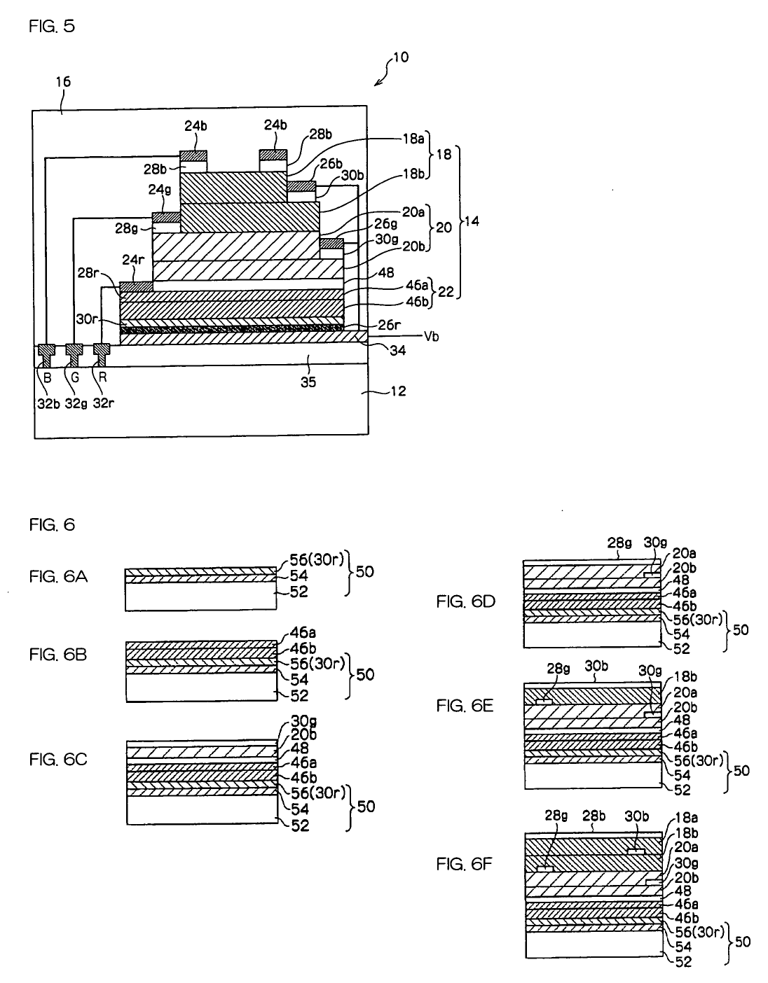

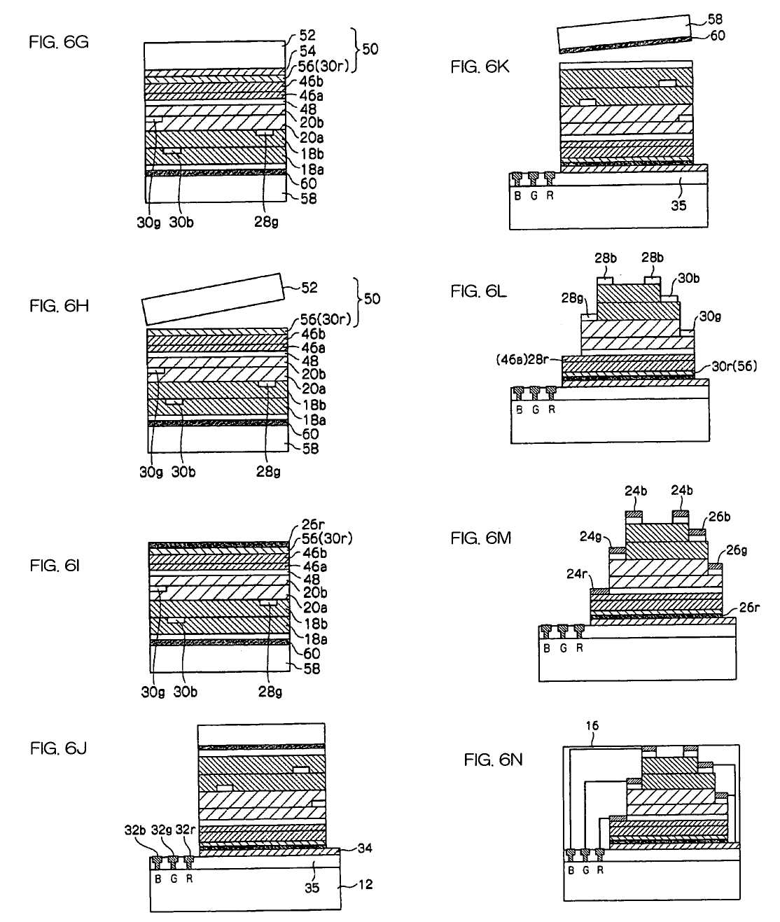

FIG. 5 is schematic drawing illustrating the configuration of a fourth embodiment of the solid-state image pickup device of the present invention. FIGS. 6A-6N are schematic drawings illustrating the production process for the fourth embodiment of the solid-state image pickup device of the present invention.

In the solid state image pickup device of this embodiment, Si single crystal is used as the third photoelectric conversion layer 22 in the photoelectric conversion unit 14. The third photoelectric conversion layer 22 has an n-Si layer 46a and an i-Si layer 46b, and additionally, a p-Si layer is used as the contact layer 30r. In addition, a GaP buffer layer 48 is placed between the second photoelectric conversion layer 20 and the third photoelectric conversion layer 22. Aside from this, the structure is the same as in the first embodiment, and thus, description thereof is omitted.

Hereinafter, a method of producing the solid state image pickup device is described.

First as shown in FIG. 6A, a SOI (Silicon On Insulator) substrate 50 is prerpared. The SOI substrate 50 has a Si substrate 52 and a thin film p-Si layer 56 formed thereon via a SiO₂ layer 54, and the p-Si layer 56 is used as a contact layer 30r.

As shown in FIG. 6B, an i-Si layer 46b and an n-Si layer 46a are then formed on the SOI substrate 50, one by one.

Then, as shown in FIG. 6C, a GaP buffer layer 48 is formed on the n-Si layer 46a for alleviation of lattice mismatching, and a p-InGaAlP layer 20b and a p-GaAs contact layer 30g are further formed thereon.

Then, as shown in FIG. 6D, the top p-GaAs contact layer 30g is removed by normal lithography while leaving part of it, exposing the p-InGaAlP layer 20b. An n-InGaAlP layer 20a and an n-GaAs contact layer 28g are then formed thereon.

Then, as shown in FIG. 6E, the top n-GaAs contact layer 28g is removed by normal lithography while leaving part of it at an area different from that of the lower p-GaAs contact layer 30g, exposing the n-InGaAlP layer 20a. A p-InAlP layer 18b and a p-GaAs contact layer 30b are then formed thereon.

Then, the top p-GaAs contact layer 30b in FIG. 6F is removed by normal lithography while leaving part of at an the area different from those of the lower p-GaAs contact layer 30g and the n-GaAs contact layer 28g, exposing the p-InAlP layer 18b. An n-InAlP layer 18a and an n-GaAs contact layer 28b are then formed thereon.

Subsequently, as shown in FIG. 6G, a SOI substrate 50 is adhered to the glass substrate 58 via a resin film 60, for protection of the epitaxial growth face.

Then, as shown in FIG. 6H, the SiO₂ layer 54 is dissolved off with a hydrofluoric acid-based etchant, removing the Si substrate 52 and exposing the p-Si layer 56 (contact layer 30r).

As shown in FIG. 6I, a Ti/Pt/Au film is then formed as a p-electrode 26r on the contact layer 30r of the p-Si layer 56.

As shown in FIG. 6J, a photoelectric conversion unit 14 is then prepared by adhering the common electrode 34 patterned in a particular shape and the bottom layer p-electrode 26r onto a signal transmission circuit board 12 separately prepared. As shown in FIG. 6K, the glass substrate 58 is then removed together with the resin film 60.

As shown in FIG. 6L, the respective GaAs contact layers are then exposed by normal lithography and dry etching techniques (excluding the p-Si contact layer 30r; the top n-GaAs contact layer 28b is patterned), and as shown in FIG. 6M, AuGe/Ni/Au films are formed respectively as n-electrodes 24r, 24g, and 24b and Ti/Pt/Au films as p-electrodes 26g and 26b on the respective GaAs contact layers (excluding the p-Si contact layer 30r) are formed respectively.

In this way, a laminated photoelectric conversion unit 14 having, from the light-receiving surface, the first photoelectric conversion layer comprising an n-InAlP layer 18a and a p-InAlP layer 18b, the second photoelectric conversion layer 20 comprising an n-InGaAlP layer 20a and a p-InGaAlP layer 20b, and the third photoelectric conversion layer 22 comprising an n-Si layer 46a and an i-Si layer 46b is formed on the signal transmission circuit board 12.

Subsequently, as shown in FIG. 6N, after forming a SiO₂ layer as a sealer 16, viaholes, viaplugs, and the like, the respective photoelectric conversion layers in the photoelectric conversion unit 14 are connected respectively via the n-electrodes 24r, 24g, and 24b to the pixel electrodes 32r, 32g, and 32b (R, G and B signal read-out electrodes) formed on the signal transmission circuit board 12 and via the p-electrodes 26g and 26b to the earth.

In this way, the solid state image pickup device 10 according to this embodiment is prepared.

As described above, in the solid state image pickup device of this embodiment, it is possible to produce the photoelectric conversion unit 14 having photoelectric conversion layers (first and second layers) of a compound semiconductor and a photoelectric conversion layer (third layer) of Si easily at low cost by using the SOI substrate 50.

It is possible to work the present invention by combining any of the above embodiments. Further, it would be understood that, in any of the above embodiments, the invention should not be understood in a restricted way and may be worked within a scope satisfying the requirements of the invention.

What is claimed is:

1. A solid state image pickup device, comprising a silicon substrate and a photoelectric conversion unit which receives external incident light and generates signals in accordance therewith, and which is formed on or above the surface of the silicon substrate, wherein
a signal transmission circuit for reading out the signals generated in the photoelectric conversion unit is formed on the silicon substrate;
the photoelectric conversion unit comprises a photoelectric conversion layer which comprises a laminated structure of plural compound semiconductor layers, which are different from each other in light wavelength to absorb and are provided within the laminated structure so that the shorter a light absorption wavelength of a compound semiconductor layer is, the closer to a light incident side the compound semiconductor layer resides; and
the plural compound semiconductor layers are respectively connected to pixel electrodes formed on the signal transmission circuit.

2. The solid state image pickup device according to claim 1, wherein
the photoelectric conversion layer comprises a laminated structure of first to third compound semiconductor layers arranged in this order along a light-incident direction;
the first compound semiconductor layer comprises an InAlP layer;
the second compound semiconductor layer comprises an InGaAlP layer; and
the third compound semiconductor layer comprises a layer selected from the group consisting of an InGaP layer, a GaAs layer and an InGaAsP layer.

3. The solid state image pickup device according to claim 2, wherein the first compound semiconductor layer has a band gap within a range of 440 to 480 nm;
the second compound semiconductor layer has a bang gap at 520 to 580 nm; and
the third compound semiconductor layer has a band gap within a range of 600 nm or greater wavelength region.

4. The solid state image pickup device according to claim 2, wherein the third compound semiconductor layer contains an InGaP layer.

5. The solid state image pickup device according to claim 1, wherein a light-shielding film is formed on or above the photoelectric conversion unit except for a light-receiving surface of the photoelectric conversion unit.

6. The solid state image pickup device according to claim 1, wherein a microlens is formed on or above a light-receiving surface of the photoelectric conversion unit.

7. A process for producing the solid state image pickup device according to claim 1, wherein the compound semiconductor layers are formed by organic metal gas-phase growth or molecular beam epitaxial growth.
